(19) United States
(12) Patent Application Publication
(10) Pub. No.: US 2023/0268535 A1
(43) Pub. Date: Aug. 24, 2023

(54) Voltage management and stabilisation system for fuel cell power system

(71) Applicants: Sergei Shubenkov, Moscow (RU); Sergei Panov, Rybinsk (RU); Konstantin Iakovlev, Batyrevo (RU)

(72) Inventors: Sergei Shubenkov, Moscow (RU); Sergei Panov, Rybinsk (RU); Konstantin Iakovlev, Batyrevo (RU)

(21) Appl. No.: 17/676,483

(22) Filed: Feb. 21, 2022

(51) Int. Cl. H01M 8/04858

(52) U.S. Cl. CPC H01M 8/04947; H01M 8/0494

(57) ABSTRACT

The present invention relates to the field of power sources associated with a conversion and control system of power sources based on fuel cells. The system comprises a control unit and at least one circuit arm with at least two fuel cell modules connected in series. Each fuel cell module has a bypass connected to the arm in parallel to the fuel cell. The system can be embodied with at least one circuit arm. When the system is embodied with two or more arms, these arms are interconnected in parallel. At that, each arm comprises the same quantity of installed fuel cell modules connected in series. The bypass is connected to the control unit in order to receive control signals. As an embodiment, each fuel cell module also comprises a DC/DC converter, which is in turn connected to the control unit in order to receive control signals.

### FIELD OF THE INVENTION

The present invention relates to the field of power sources associated with a conversion and control system of power sources based on fuel cells.

### BACKGROUND

The prior art includes a DC/DC converter, a DC/DC converter apparatus, a vehicle, a fuel cell system, and a method of driving a DC/DC converter. EP2075900 (2009-07-01, Honda). The publication relates to a DC/DC converter to increase and/or decrease DC voltage, a DC/DC converter apparatus comprising a DC/DC converter, and a method of driving a DC/DC converter. Under the same target voltage, a basic duty ratio depending on a target ON time is set, and prior and subsequent duty ratios before and after upper arm switching devices (81, 81u, 81v, 81w) or lower arm switching devices (82, 82u, 82v, 82w) are driven with the basic duty ratio are set as a basic duty ratio+a and a basic duty ratio—a, respectively. Gate drive signals, having the basic duty ratio and the prior and subsequent duty ratios, are supplied to the upper arm switching devices (81, 81u, 81v, 81w) or to the lower arm switching devices (82, 82u, 82v, 82w), in order to turn on the upper arm switching devices (81, 81u, 81v, 81w) or the lower arm switching devices (82, 82u, 82v, 82w).

The prior art includes a fuel cell module. US20070178345A1 (2007-08-02, Hitachi Ltd). The fuel cell module described in the publication includes a fuel cell stack and a power converter incorporated respectively in the casing. The power converter has a printed circuit board and a switching semiconductor. The printed circuit board is arranged between the switching semiconductor and the fuel cell stack, thereby cutting off the radiation of heat from the fuel cell stack to the switching semiconductor, and reducing the conduction loss of the switching semiconductor. Further, a high frequency transformer equipped with a Ferrite core is arranged on the side of the fuel cell stack of the printed circuit board, thereby reducing the iron loss in the high frequency transformer. The single similarity with the presented system is that the converter is incorporated in the FC module casing.

The prior art includes a DC/DC conversion and control system based on fuel cells with a proton-exchange membrane. CN102904444 (2015-01-21, UNIV SHANGHAI JIAOTONG). The publication discloses a conversion and control system for a DC/DC converter comprising a core circuit module and a control circuit module, wherein the core circuit module comprises a two-stage parallel converter. The system is suitable for power conversion of the output power equipment and fuel cells with a proton-exchange membrane, which may result in lower cost and higher reliability of the system.

### SUMMARY

The object of the present invention is creation of a stabilised DC voltage power generation system based on fuel cells.

The technical result of the claimed technical solution is higher operating efficiency of the power source and lesser weight of the system as a whole.

The technical result of the claimed technical solution is achieved through that the stabilised DC voltage power generation system comprises a control unit and at least one circuit arm with at least two fuel cells connected in series. At that, each fuel cell module comprises a bypass connected to the arm in parallel to the fuel cell and each fuel cell module also comprises a step-down DC/DC converter, which is in turn connected to the control unit in order to receive control signals.

As a particular embodiment of the claimed technical solution, the system additionally comprises the second circuit arm connected in parallel to the above circuit arm. At that, each arm comprises the same quantity of installed fuel cells connected in series.

As a particular embodiment of the claimed technical solution, the system comprises many circuit arms interconnected in parallel. At that, each arm comprises the same quantity of installed fuel cells connected in series.

As a particular embodiment of the claimed technical solution, the bypass is connected to the control unit in order to receive control signals.

As a particular embodiment of the claimed technical solution, the converter is step-down multi-phase type.

The technical result of the claimed technical solution is also achieved through that the stabilised DC voltage power generation system comprises a control unit and at least one circuit arm with at least two fuel cells connected in series. At that, each fuel cell module comprises a bypass connected to the arm in parallel to the fuel cell module and each arm comprises one step-down DC/DC converter, which is in turn connected to the control unit.

As a particular embodiment of the claimed technical solution, the system additionally comprises the second circuit arm connected in parallel to the above circuit arm. At that, each arm comprises the same quantity of installed fuel cells connected in series.

As a particular embodiment of the claimed technical solution, the system comprises many circuit arms interconnected in parallel. At that, each arm comprises the same quantity of installed fuel cells connected in series.

As a particular embodiment of the claimed technical solution, the bypass is connected to the control unit in order to receive control signals.

As a particular embodiment of the claimed technical solution, the converter is step-down multi-phase type.

The advantage of the step-down converter is that voltage adjustment at the single fuel cell module and quantity of modules in the arm with serial connection allow obtaining a conversion ratio close to 1 at the peak power and resulting maximum conversion efficiency (more than 99.5%) at the maximum power. Losses in chokes and keys of the step-down converter depend both on power and on conversion ratio. At that, they are minimal at a conversion ratio close to 1. At a lower power, the conversion ratio decreases to values in range from ⅔ to 1, since the fuel cell module outputs a higher voltage at a lower power. However, losses remain moderate due to lower currents (at a lower power). Thanks to this combination (maximum power at the minimum deviation of the conversion ratio from 1), the power part of the step-down converter (chokes and keys) is smaller and the system weight is accordingly lesser. On the other hand, if a step-up converter is used, the conversion ratio will be farthermost from 1 at the maximum power. This will result in significant growth of losses and require installation of larger components in the power part.

### BRIEF DESCRIPTION OF THE DRAWINGS

The details, features, and advantages of the present invention follow from the below description of embodiments of the claimed technical solution using the drawings, which show the following:

FIG. 1 is a general view of the stabilised DC voltage power generation system based on fuel cells in the embodiment, wherein the DC/DC converter is incorporated in the fuel cell module (embodiment 1);

FIG. 2 illustrates the stabilised DC voltage power generation system based on fuel cells in the embodiment, wherein one DC/DC converter is installed to an arm (embodiment 2).

The following positions are marked with digits in the figures: 1— FC module; 2— Bypass key; 3— DC/DC converter; 4— Control unit; 5— Bypass control; 6— FC parameters; 7— V-output control.

The present invention discloses a DC/DC conversion and control system. Fuel cell (FC) modules are connected to a serial-parallel network for optimal operation of the system. Hereinafter, the arm is the serial connection of the fuel cell (FC) modules; the system is the serial-parallel network.

The stabilised DC voltage power generation system comprises at least one arm each with at least two fuel cell modules.

The embodiment of the claimed technical solution provides for possible expansion of the system using additional circuits connected in parallel and fuel cell modules.

Each fuel cell (FC) module comprises a stack in turn representing fuel cell assemblies. Each stack has two current terminals: plus and minus.

In the claimed technical solution, each fuel cell module of the presented arm has a bypass (key), which is connected to the above arm in parallel to the fuel cell module. In addition, each fuel cell module and each bypass are connected to the control unit via the control circuit. If a fuel cell module fails, data are sent to the control unit, which transmits signals to the bypass control, and the bypass circuit of the failed fuel cell module is closed. This maintains integrity of the arm, where the fuel cell module is installed.

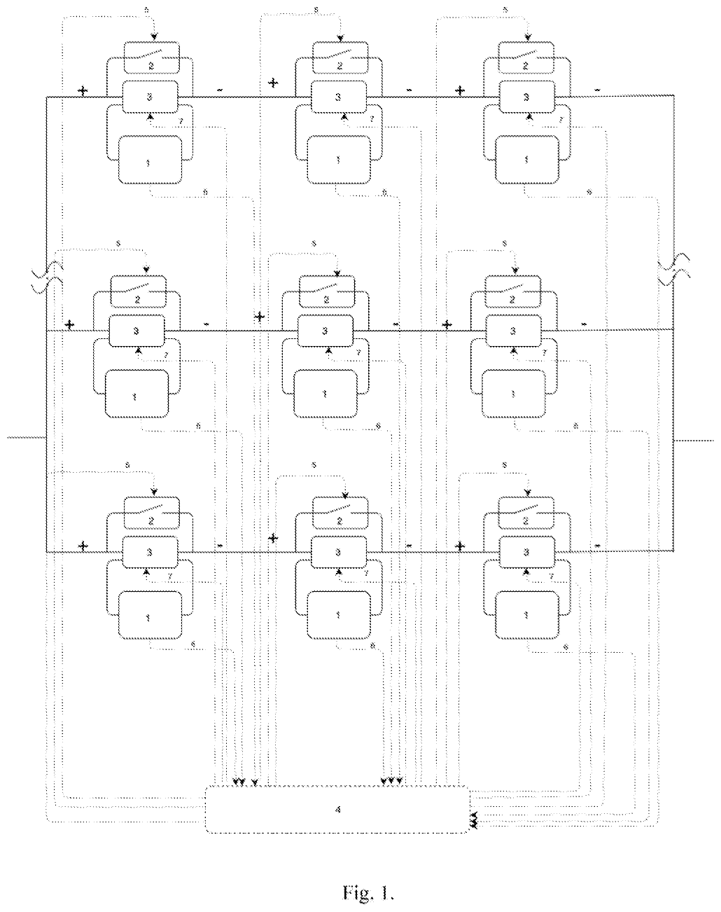

Each FC module also has an integrated step-down DC/DC converter (FIG. 1) connected to the control unit via the control circuit.

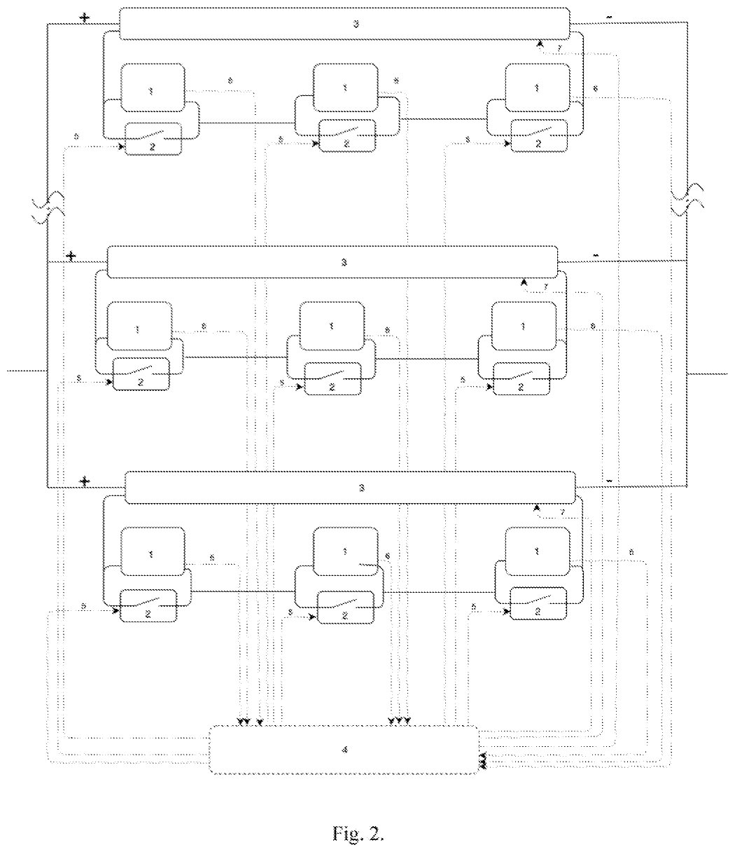

The embodiment of the claimed technical solution provides for installation of one DC/DC converter to one arm (FIG. 2). The system expansion embodiment provides for each arm with one DC/DC converter connected to the control unit via the control circuit.

Both configurations of the system allows operation and voltage correction, if a Fuel Cell (FC) Module Fails.

### Example

The system as a whole comprises 14 fuel cell (FC) modules: 7 FC modules in one arm and 7 FC modules in the parallel arm. The total voltage in one arm is 350 V; power of one FC module is 10 kW (output voltage=50 V). At that, the module stack also outputs 50 V in the maximum power mode, which ensures the DC/DC conversion ratio at 1 in this mode. Efficiency of the DC/DC converter installed to each module is 99.7% in the maximum power mode. Power losses transferred to heat equal to 0.3% multiplied by 10 kW that is 30 W. Weight of the DC/DC converter is 600 g.

If one FC module fails, data are sent to the control unit (FIG. 1), which transmits signals to the bypass control, and the bypass circuit of the failed FC module is closed. At the same time, the control unit transmits signals to the DC/DC converter or converters of all other modules in the arm for correction of voltage and output power for the modules of this arm. Voltage at each operating FC module is increased from 50 V to ≈58 V; power and current in the arm are decreased, but the arm continues operating at the former electrical voltage. If power consumption is decreased, for instance, to 50% of maximum power capacity, then output voltage at each operating FC module is increased from 50 V to ≈70 V and each step-down converts this voltage to 50 V with conversion ratio at about 0.7. Efficiency of the DC/DC converter will decrease to 99.0%, but absolute power losses remain moderate as they equal 1.0% multiplied by two times lower power output (5 kW), that is 50 W.

1. A stabilised DC voltage power generation system, comprising:
a control unit;
at least one circuit arm with at least two fuel cell modules connected in series;
at that, each fuel cell module has a bypass connected to the arm in parallel to the fuel cell module;
each fuel cell module also comprises a DC/DC converter, which is in turn connected to the control unit in order to receive control signals.

2. The system of claim 1, wherein it additionally comprises the second circuit arm connected in parallel to the above circuit arm. At that, each arm comprises the same quantity of installed fuel cells connected in series.

3. The system of claim 1, wherein it comprises many circuit arms interconnected in parallel. At that, each arm comprises the same quantity of installed fuel cells connected in series.

4. The system of claim 1, wherein the bypass is connected to the control unit in order to receive control signals.

5. The system of claim 1, wherein the converter is step-down type.

6. A stabilised DC voltage power generation system, comprising:
a control unit;
at least one circuit arm with at least two fuel cell modules connected in series;
at that, each fuel cell module has a bypass connected to the arm in parallel to the fuel cell module;
each arm also comprises one DC/DC converter, which is in turn connected to the control unit.

7. The system of claim 6, wherein it additionally comprises the second circuit arm connected in parallel to the above circuit arm. At that, each arm comprises the same quantity of installed fuel cells connected in series.

8. The system of claim 6, wherein it comprises many circuit arms interconnected in parallel. At that, each arm comprises the same quantity of installed fuel cells connected in series.

9. The system of claim 6, wherein the bypass is connected to the control unit in order to receive control signals.

10. The system of claim 6, wherein the converter is step-down type.
